(19) United States
(12) Patent Application Publication
(10) Pub. No.: US 2026/0166773 A1
(43) Pub. Date: Jun. 18, 2026

(54) GRINDING MILL AND GRINDING APPARATUS

(71) Applicant: GLOBUS S.r.l., Galliate (IT)

(72) Inventor: Fabio Paron, Galliate (IT)

(21) Appl. No.: 19/407,191

(22) Filed: Dec. 3, 2025

(30) Foreign Application Priority Data
Dec. 17, 2024 (IT) 102024000028647

(51) Int. Cl. B27L 11/02; B27L 11/00

(52) U.S. Cl. CPC B27L 11/02; B27L 11/005

(57) ABSTRACT

Grinding mill for obtaining wood strands starting from wood chips, comprising:
an enclosure structure in which an opening is made through which the chips can be introduced inside the structure;
a ring drum placed inside the structure, wherein the drum has a substantially horizontal central axis and an internal surface and comprises a plurality of cutting elements that internally protrude from the internal surface;
a rotor placed within the ring drum, wherein the rotor comprises a plurality of impact elements placed on a circle centred on the central axis;
actuation means actuatable to rotate the rotor and/or the drum relative to each other around the central axis, moving each impact element relative to the cutting elements in a corresponding tangential direction;
   wherein the rotor comprises a plurality of holding elements, wherein each holding element is associated with a corresponding impact element so as to protrude with respect to it in the corresponding tangential direction and to define with it a seat suitable to receive at least one chip.

The present invention relates to a grinding mill, whose function is to obtain wood strands (better known with the English term “strands”) by repeatedly cutting wood chips of elongated shape (better known with the English term “chips,” or more specifically “macro-chips”), and to a grinding apparatus comprising such a mill.

In the field of wood processing, panel boards made from wood strands, such as for example Oriented Strand Board (also known as “OSB”) and Particle Board (also known as “PB”), have long been known.

Such panel boards are usually made by mixing wood strands with glues and adhesive substances, and then compacting such mixture with suitable presses. The wood strands, in turn, are previously obtained by a first chipping process which allows the starting wood (which can consist, for example, of raw wood or already processed wood being recycled) to be reduced to wood chips of elongated shape, and a second grinding process during which the chips are further cut in order to obtain the actual strands.

The grinding process is usually performed using a grinding mill. Generally, such grinding mill comprises, first of all, an enclosure structure in which an opening is made through which the wood chips can be introduced inside the structure. The mill then comprises a ring-shaped drum positioned inside the enclosure, having a horizontal central axis and an internal surface from which cutting elements internally protrude and on which the chips are placed once introduced inside the structure, and a rotor placed inside the drum so as to be able to rotate with respect to it around the central axis. The rotor comprises, in particular, a plurality of support elements which are placed on a circle centred on the central axis, wherein an impact element that externally protrudes from the corresponding support element is fixed to each support element.

The mill finally comprises actuation means actuatable to rotate the rotor with respect to the drum: by rotating the rotor, the impact elements move the chips along the internal surface of the drum, pushing them against the cutting elements to perform the cuts which allow the strands of the desired size to be obtained.

However, it has been observed that such solution has some drawbacks. First of all, it has been observed that the strands obtained in this way are on average shorter than the starting chips; considering that the greater the length of the strands and the greater the quality and strength of the panels made therewith, the strands obtained according to the known methods allow to make panels of limited quality, unless a difficult and laborious operation of selecting only the longest strands is carried out, and all the others are discarded.

Furthermore, with the same number of other structural features such as the number of cutting elements and impact elements, it would be desirable to increase the productivity of the mill, so as to subsequently make a greater number of panel boards in the same amount of time.

An object of the present invention is to overcome the above-mentioned drawbacks, and in particular to make a grinding mill and a grinding apparatus capable of obtaining wood strands of sufficient length to produce quality panel boards, minimizing waste and increasing the overall productivity with the same number of other structural features.

A further object of the present invention is to achieve an efficient size reduction also of wood chips obtained from recycled wood.

These and other results are achieved according to the present invention by making a grinding mill according to claim 1, and a grinding apparatus according to claim 6. Further features of the invention are the object of the dependent claims.

The present invention will now be described, by way of illustration but not limitation, according to its preferred embodiments, with reference to the attached drawings, in which:

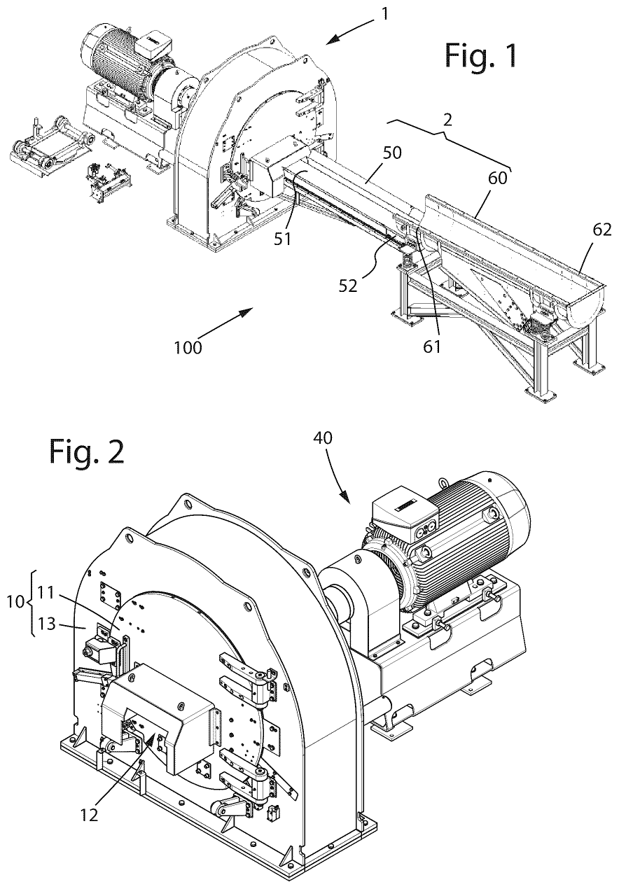

FIG. 1 is a perspective view of a grinding apparatus according to the invention;

FIG. 2 is a perspective view of a grinding mill according to the invention;

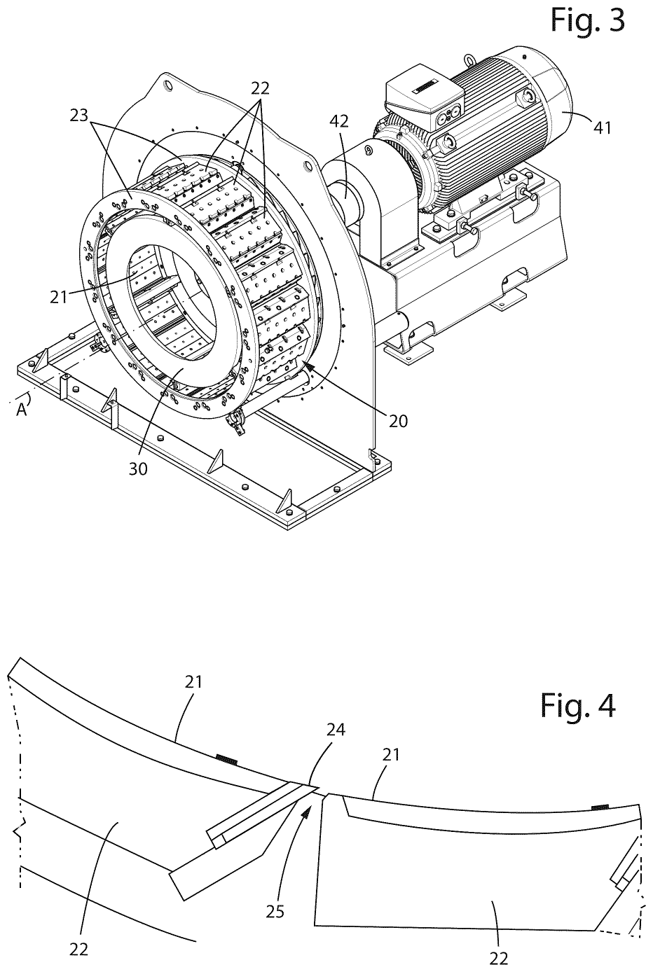

FIG. 3 is a view of FIG. 2 with parts removed for clarity;

FIG. 4 is an enlarged front view of a detail of a drum of the mill according to the invention;

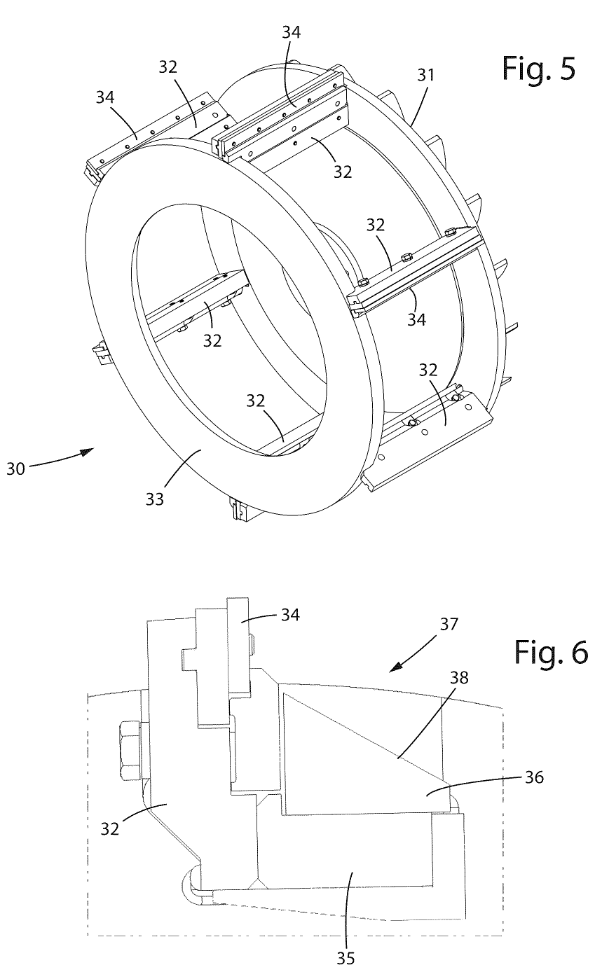

FIG. 5 is a perspective view of a rotor of the mill according to the invention, with parts removed for clarity;

FIG. 6 is an enlarged front view of a detail of a rotor of the mill according to the invention;

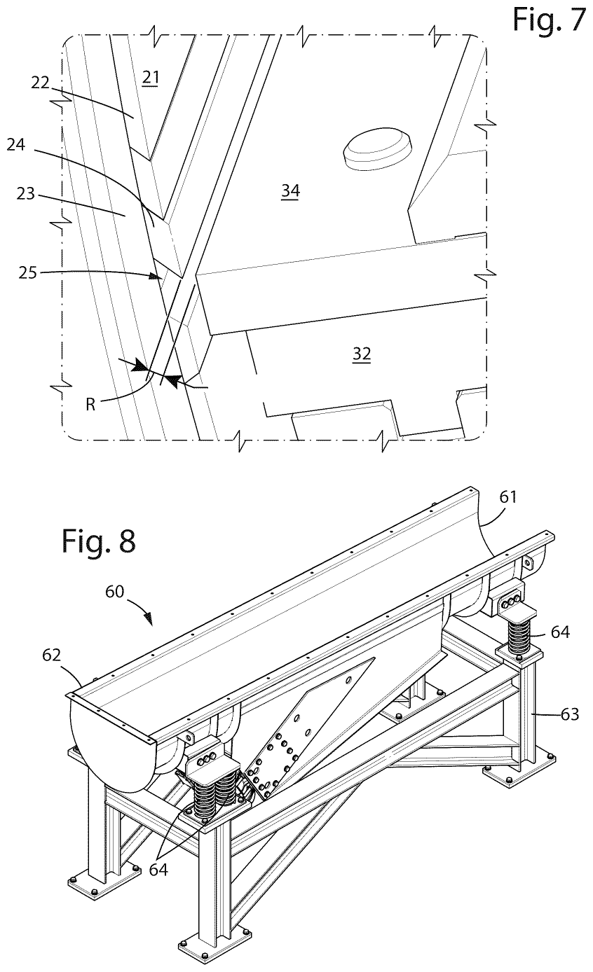

FIG. 7 is an enlarged view of a detail of FIG. 3;

FIG. 8 is a perspective view of an orientation feeder of an apparatus according to the invention;

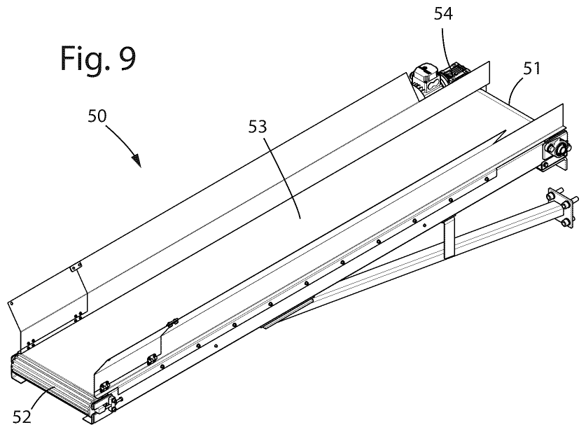

FIG. 9 is a perspective view of a conveyor belt of an apparatus according to the invention.

With reference to FIG. 1, 100 indicates as a whole a grinding apparatus usable to obtain wood strands by cutting one or more times a plurality of wood chips. Each wood chip is produced by a previous chipping process (known and not described) and generally has an elongated shape, i.e. such that it has one dimension (length) prevailing over the other two (width and thickness); a chip (better known by the English term “chip”, or more specifically “macro-chip”) can have, for example, a parallelepiped or cylinder shape, with a length in the order of 100 millimetres and a width and a thickness in the order of 50 millimetres.

The apparatus 100 comprises in particular a grinding mill 1, inside which a grinding chamber is defined, wherein the wood chips are cut to obtain the strands, and supply means 2 actuatable to introduce the chips inside the mill 1.

With reference to FIG. 2, the mill 1 first comprises a machine body 13 on whose front surface a service mouth is made; such service mouth can be closed by a door 11 hinged to the machine body 13 itself by two vertical-axis hinges; together, the machine body 13 and the door 11 form an enclosure structure 10, inside which the grinding chamber is defined. In the lower portion of the door 11, an opening 12 is made through which, when the grinding mill 1 is in use and the door 11 is closed, the wood chips can be introduced into the grinding chamber to be ground.

With reference to FIG. 3, the mill 1 also comprises a ring-shaped drum 20 positioned inside the enclosure 10 with the central axis A thereof placed substantially horizontally. In this way, a set of three mutually perpendicular reference directions can be defined point by point, comprising an axial direction parallel to the central axis A, a radial direction, and a tangential direction.

The drum 20 has an internal surface 21 on which the wood chips are positioned once introduced into the enclosure structure 10 through the opening 12, and extends in width along the axial direction substantially for the entire extension of the machine body 13: in this way, the chips placed on the internal surface 21 cannot laterally escape from the drum 20.

More particularly, the drum 20 is composed of a plurality of bases 22 placed on a circle centred on the central axis A and laterally fixed to two first enclosure rings 23, so as to define, with the respective inner faces, the internal surface 21 of the drum 20. With reference to FIG. 4, each base 22 comprises a cutting element 24 placed so as to internally protrude with respect to the internal surface 21 of the drum 20, i.e., so as to protrude from the internal surface 21 along a direction having at least a component along the corresponding radial direction; each cutting element 24 consists particularly of a knife extending axially for the entire width of the drum 20. The bases 22 are fixed to the first enclosure rings 23 so that a slot 25 is defined between each pair of bases 22 adjacent to each other, adjacent to each cutting element 24 and having a predetermined width measured in the tangential direction.

Still with reference to FIG. 3, the mill 1 further comprises a rotor 30 placed coaxially inside the drum 20 so that the rotor 30 and/or the drum 20 can rotate relative to each other around the central axis A. Preferably, the drum 20 in use is fixed to the machine body 13, while the rotor 30 rotates with respect to the drum 20 around the central axis A; however, in an alternative embodiment, the drum 20 can also rotate around the central axis A, in the direction opposite to that of the rotation of the rotor 30.

With reference to FIG. 5, the rotor 30 comprises a support disk 31 centred on the central axis A, and a plurality of support elements 32 (also known as “arms”) extending axially fixed at one end to the support disk 31 and at the other to a second enclosure ring 33, so as to lie on a circle centred on the central axis A, equidistant from each other. An impact element 34 that externally protrudes from the corresponding support element 32 along the corresponding radial direction, is coupled (preferably in a reversible manner) to each support element 32: in this way, the impact elements 34 are also placed on a circle centred on the central axis A.

More particularly, with reference to FIG. 7, each impact element 34 consists of a counter-knife extending axially for a length substantially equal to the axial extension of the knives, and is coupled to the corresponding support element 32 so that the radial distance R between the knives and the counter-knives allows to perform the cuts of the chips while preventing them from being crushed between the knives and counter-knives, a crushing that would cause tearing and fraying of the chips and the production of dusts and micro-particles, thus obtaining lower-quality strands.

Still with reference to FIG. 3, the mill 1 comprises actuation means 40 actuatable to rotate the rotor 30 and/or the drum 20 relatively to each other around the central axis A, thereby moving the impact elements 34 relative to the cutting elements 24 in the tangential direction. The actuation means 40 can comprise, for example, an electric motor 41 connected to the support disk 31 of the rotor 30 by a coupling 42.

In this way, the impact elements 34 push tangentially along the internal surface 21 of the drum 20 the wood chips introduced into the grinding chamber, bringing them against the cutting elements 24 which perform their cut, separating the wood chip in question in two parts, i.e., a strand having the dimensions required to escape from the drum 20 passing through the slot 25 adjacent to the cutting element 24 which performed the cut, and a remaining chip that is subsequently subjected to further cuts to obtain as many further strands. It is therefore apparent that the dimensions, and thus the quality, of the strands obtained depend on the protrusion of the cutting elements 24 with respect to the internal surface 21 of the drum 20, on the tangential width of the slots 25, and on the radial distance R between the impact elements 34 and the cutting elements 24.

With reference to FIG. 6, a connecting element 35 is coupled (preferably in a reversible manner) to each support element 32 so as to be positioned radially inwards with respect to the impact element 34 coupled to the same support element 32, and a holding element 36 that tangentially protrudes from the impact element 34 associated therewith (i.e., coupled to the same support element 32) is coupled (preferably in a reversible manner) to each connecting element 35, in the same direction in which the supporting element 32 moves with respect to the cutting elements 24 when the rotor 30 rotates with respect to the drum 20. In this way, each holding element 36 defines, together with the impact element 34 associated therewith, a seat 37 (also referred to as a “pocket”) in which one or more chips to be ground can be received. Indeed, it has been observed that in known solutions, one of the reasons that cause the reduction of the average length of the strand obtained from the mill 1 consists in that, after cutting a chip between the impact element 34 and the cutting element 24, the remaining chip which remains inside the drum 20 is usually projected, by reaction, in a random direction in space, orienting itself just as randomly once it returns resting on the internal surface 21 of the drum 20 after bouncing one or more times on the internal surface 21 itself: it is therefore very likely that the remaining chip is placed on the internal surface 21 with the extending direction thereof inclined with respect to the cutting element 24, and that the subsequent cut will thus reduce its length.

On the other hand, the holding element 36 prevents the remaining chips from being projected in a random direction following the cuts, and instead keeps them in the seat 37 with the extending direction thereof substantially parallel to the cutting element 24, i.e., oriented axially. Consequently, the subsequent cut occurs with the cutting element 24 placed parallel to the extending direction of the remaining chip, which is thus thinned but not shortened. This allows to obtain strands of greater average length, and therefore to subsequently produce panel boards of better quality, avoiding the need to discard large quantities of strands because they are too short. Furthermore, it has been observed that the fact that the remaining chips are kept in the seats 37 by the holding elements 36 allows to perform a plurality of consecutive cuts (by consecutive cutting elements 24) on the same material received in the same seat 37, minimizing the average residence time of the material inside the grinding chamber. This also allows, with the same other structural features, to increase the overall productivity of the mill 1.

The invention described above also minimizes the number of cuts that each chip undergoes in succession to obtain strands of the required dimensions. As a result, the mill 1 is particularly useful for grinding recycled wood chips: indeed, such wood, having already undergone previous processing, has resistance features different from raw wood, and an excessive number of cuts tends to quickly compromise the final quality of the strands obtained therefrom.

Furthermore, the greater intrinsic efficiency of the grinding process possibly allows to reduce the overall number of cutting elements 24 and impact elements 34 with respect to known solutions, and to space them further apart along the respective circles, while maintaining a high overall productivity of the mill 1. In this way, more time is given to the remaining chips to be repositioned in the respective seats 37 after each cut, thus allowing the subsequent cut to also occur with the cutting element 24 placed parallel to the extending direction of the remaining chip.

Preferably, the holding element 36 has a holding surface 38 that tangentially protrudes from the impact element 34 associated therewith and is internally inclined with respect to the tangential direction. It has indeed been observed that such configuration allows the chips to be easily inserted into the seat 37, while still preventing them from escaping therefrom after a cut. The holding surface 38 can be smooth, or it can have roughness of suitable shape and size to further prevent the remaining chips from escaping from the seat 37. The exact shape, geometry and dimensions of each holding element 36 can vary depending on the shape and size of the chips to be ground. Preferably, the holding element 36 has a wedge-shaped structure, with a radial section that progressively reduces when proceeding away from the support element 32 to which it is fixed. Indeed, it has been observed that such configuration is particularly robust and resistant.

Still with reference to FIG. 1, the supply means 2 comprise a conveyor belt 50 and an orientation feeder 60. The conveyor belt 50 extends along a conveying direction substantially parallel to the central axis A, and has a first end 51 that faces the opening 12 in the structure 10 of the mill 1 and a second end 52 opposite to the first end 51. The orientation feeder 60 has a concave shape and extends along an orienting direction that is inclined upwards with respect to the conveying direction: the orientation feeder 60 thus has an open lower end 61 placed above the conveyor belt 50 (in particular above the second end 52), and an upper end 62 opposite to the lower end 61.

With reference to FIG. 8, the orientation feeder 60 has a semi-circular cross-section, and the chips to be ground, which initially tend to be placed in a random orientation, are loaded therein. The orientation feeder 60 is also vibration-actuatable: in this way, the chips received therein tend to be autonomously oriented parallel to the orienting direction and to advance towards the lower end 61 until falling on the conveyor belt 50. More particularly, the orientation feeder 60 is suspended on a supporting scaffold 63 by a plurality of springs 64, and is vibration-actuatable by one or more vibration actuators (not visible in the figures).

With reference to FIG. 9, the conveyor belt 50 comprises a belt 53 wound on two rollers between the first end 51 and the second end 52, and a conveying actuator 54 actuatable to circulate the belt 53 so as to advance the wood chips placed on the belt 53 towards the first end 51 and introduce them into the grinding chamber through the opening 12. Since the orienting direction is inclined vertically with respect to the conveying direction, the chips oriented along the orienting direction by the orientation feeder 60 are generally aligned along the conveying direction once they fall on the conveyor belt 50: this allows to introduce the chips inside the mill 1 being already axially aligned, i.e., substantially parallel to the cutting elements 24. In this way, it is very likely that the first cut of the chip occurs with the cutting element 24 placed parallel to the extending direction of the chip, maximizing the length of the strand thus obtained.

Furthermore, preferably, the orientation feeder 60 allows to advance the chips with a first speed, while the conveyor belt 50 allows to advance the chips with a second speed which is greater than the first speed. This allows to further increase the likelihood that the chips falling on the conveyor belt 50 from the orientation feeder 60 are axially aligned.

In an alternative embodiment, not depicted in the figures, the belt has a concave cross-section, in order to better hold the chips while they are being advanced.

In an alternative embodiment, not depicted in the figures, the supply means 2 comprise a fall supply device, actuatable to introduce the chips into the grinding chamber through the opening 12 by the effect of gravity.

The present invention has been described, by way of illustration but not limitation, according to its preferred embodiments, but it is to be understood that variations and/or modifications can be made by a person skilled in the art without thereby departing from the related scope of protection as defined in the attached claims.

1) Grinding mill (1) for obtaining wood strands starting from wood chips, comprising:
an enclosure structure (10) in which an opening (12) is made through which the chips can be introduced inside the structure (10);
a ring drum (20) placed inside the structure (10), wherein the drum (20) has a substantially horizontal central axis (A) and an internal surface (21) and comprises a plurality of cutting elements (24) that internally protrude from the internal surface (21);
a rotor (30) placed inside the drum (20), wherein the rotor (30) comprises a plurality of impact elements (34) placed on a circle centred on the central axis (A);
actuation means (40) actuatable to rotate the rotor (30) and/or the drum (20) relative to each other around the central axis (A), moving each impact element (34) relative to the cutting elements (24) in a corresponding tangential direction;
characterized in that the rotor (30) comprises a plurality of holding elements (36), wherein each holding element (36) is associated to a corresponding impact element (34) so as to protrude from it in the corresponding tangential direction and to define with it a seat (37) suitable to receive at least one chip.

2) Mill (1) according to claim 1, wherein each holding element (36) protrudes from the corresponding impact element (34) in the corresponding tangential direction with a holding surface (38) that is inclined towards the central axis (A) with respect to the corresponding tangential direction.

3) Mill (1) according to claim 2, wherein each holding element (36) has a wedge-shaped structure having a radial dimension that progressively reduces when proceeding away from the corresponding impact element (34) in the corresponding tangential direction.

4) Mill (1) according to any of the preceding claims, wherein the rotor (30) comprises a plurality of support elements (32), wherein each holding element (36) is reversibly couplable to the corresponding support element (32).

5) Mill (1) according to any of the preceding claims, wherein each cutting element (24) consists in a knife (24) that extends substantially parallel to the central axis (A), and wherein each impact element (34) consists in a counter-knife (34) that extends substantially parallel to the central axis (A).

6) Grinding apparatus (100) for obtaining wood strands starting from wood chips, comprising:
a mill (1) according to any of claims 1 to 5;
supply means (2) actuatable to introduce the chips inside the structure (10) through the opening (12).

7) Apparatus (10) according to claim 6, wherein the supply means (2) comprise:
a conveyor belt (50) that extends along a conveying direction substantially parallel to the central axis (A) and has a first end (51) that faces the opening (12) and a second end (52) opposite to the first end (51), the conveyor belt (50) being actuatable for advancing the chips placed thereon towards the first end (51);
a concave orientation feeder (60) that extends along an orienting direction that is inclined upwards with respect to the conveying direction and has an open lower end (61) placed above the conveyor belt (50), the orientation feeder (60) being shaped so as to be able to receive a plurality of chips and being also vibration-actuatable for orienting the chips received therein substantially parallel to the orienting direction and for advancing them towards the lower end (61).

8) Apparatus (100) according to claim 7, wherein the orientation feeder (60) has a semi-circular cross-section.

9) Apparatus (100) according to any of claims 7 or 8, wherein the orientation feeder (60) is vibration-actuatable for advancing the chips received therein towards the lower end (61) with a first speed, and the conveyor belt (50) is actuatable for advancing the chips placed thereon towards the first end (51) with a second speed greater than the first speed.
